(19) United States
(12) Patent Application Publication
(10) Pub. No.: US 2007/0286771 A1
(43) Pub. Date: Dec. 13, 2007

(54) Chemical analysis coupon for the presence of explosives

(75) Inventors: Peter J. Nunes, Danville, CA (US); Joel Del Eckels, Livermore, CA (US); Marina L. Chiarappa-Zucca, Livermore, CA (US); Armando Alcaraz, Livermore, CA (US); Richard E. Whipple, Livermore, CA (US)

Correspondence Address: Eddie E. Scott;Assistant Laboratory Counsel, Lawrence Livermore National Laboratory, P.O. Box 808,L-703, Livermore, CA, 94551, US

(73) Assignee: The Regents of the University of California

(21) Appl. No.: 11/165,474

(22) Filed: Jun. 22, 2005

Related U.S. Application Data
(60) Provisional application No. 60/583,165, filed on Jun. 24, 2004.

(51) Int. Cl. G01N 31/22

(52) U.S. Cl. 422/58

(57) ABSTRACT

An inspection tester system for testing for explosives comprising a body, a lateral flow membrane swab unit operably connected to the body, a first explosives detecting reagent, a first reagent holder and dispenser operatively connected to the body, the first reagent holder and dispenser containing the first explosives detecting reagent and positioned to deliver the first explosives detecting reagent to the lateral flow membrane swab unit, a second explosives detecting reagent, and a second reagent holder and dispenser operatively connected to the body, the second reagent holder and dispenser containing the second explosives detecting reagent and positioned to deliver the second explosives detecting reagent to the lateral flow membrane swab unit.

### CROSS-REFERENCE TO RELATED APPLICATIONS

This application claims the benefit of U.S. Provisional Patent Application No. 60/583,165 titled “Chemical Analysis Coupon for the Presence of Explosives” filed Jun. 24, 2004 by Peter J. Nunes, Joel Del Eckels, Marina L. Chiarappa-Zucca, Armando Alcaraz, and Richard E. Whipple. U.S. Provisional Patent Application Patent Application No. 60/583,165 filed Jun. 24, 2004 is incorporated herein by this reference.

The United States Government has rights in this invention pursuant to Contract No. W-7405-ENG-48 between the United States Department of Energy and the University of California for the operation of Lawrence Livermore National Laboratory.

### BACKGROUND

1. Field of Endeavor

The present invention relates to explosives and more particularly to testing for the presence of explosives.

2. State of Technology

U.S. Pat. No. 5,638,166 for an apparatus and method for rapid detection of explosives residue from the deflagration signature thereof issued Jun. 10, 1997 to Herbert O. Funsten and David J. McComas and assigned to The Regents of the University of California provides the following state of the art information, “Explosives are a core component of nuclear, biological, chemical and conventional weapons, as well as of terrorist devices such as car, luggage, and letter bombs. Current methods for detecting the presence of explosives include vapor detection, bulk detection, and tagging. However, these methods have significant difficulties dependent upon the nature of the signature that is detected. See, Fetterolf et al., Portable Instrumentation: New Weapons in the War Against Drugs and Terrorism,” Proc. SPIE 2092 (1993) 40, Yinon and Zitrin, in Modern Methods and Applications in Analysis of Explosions, (Wiley, New York, 1993) Chap. 6; and references therein. Vapor detection is achieved using trained animals, gas chromatography, ion mobility mass spectrometry, and bioluminescence, as examples. All of these techniques suffer from the inherently low vapor pressures of most explosives. Bulk detection of explosives may be performed using x-ray imaging which cannot detect the explosives themselves, but rather detects metallic device components. Another method for bulk detection involves using energetic x-rays to activate nitrogen atoms in the explosives, thereby generating positrons which are detected. This technique requires an x-ray generator and a minimum of several hundred grams of explosives. Bulk detection is also accomplished using thermal neutron activation which requires a source of neutrons and a .gamma.-radiation detector. Thus, bulk detection is not sensitive to trace quantities of explosives and requires large, expensive instrumentation. Tagging requires that all explosives be tagged with, for example, an easily detected vapor. However, since tagging is not mandatory in the United States, this procedure is clearly not reliable. It turns out that there are no technologies for performing accurate, real-time (<6 sec) detection and analysis of trace explosives in situ. Only trained dogs can achieve this goal.

It is known that surfaces in contact with explosives (for example, during storage, handling, or device fabrication) will readily become contaminated with explosive particulates as a result of their inherent stickiness. This phenomenon is illustrated in studies that show large persistence of explosives on hands, even after several washings (J. D. Twibell et al., “Transfer of Nitroglycerine to Hands During Contact with Commercial Explosives,” J. Forensic Science 27 (1982) 783; J. D. Twibell et al., “The Persistence of Military Explosives on Hands,” J. Forensic Science 29 (1984) 284). Furthermore, cross contamination in which a secondary surface is contaminated by contact with a contaminated primary surface can also readily occur. For example, a measurable amount of ammonium nitrate (AN) residue has been found on the lease documents for a rental truck, and significant amounts of the explosives PETN (pentaerythritol tetranitrate) and/or AN have been found on clothing and inside vehicles of suspects in two well-publicized bombings. Therefore, explosive residue will likely persist in large amounts on the explosive packaging and environs, as well as on the individuals involved in building the explosive device, which can provide an avenue for detection of the presence of explosives.

U.S. Pat. No. 5,679,584 for a method for chemical detection issued Oct. 2, 1997 to Daryl Sunny Mileaf and Noe Esau Rodriquez, II provides the following state of the art information, “a method for detecting a target substance which includes collecting a substance sample; introducing the substance sample into a substance card having at least one preselected reagent responsive to the presence of the target substance and having a light-transmissive chamber; and inserting the substance card into a substance detector device having a photosensor and adapted to receive the substance card. Once the substance detector card has been inserted into the substance detector, the method continues by mixing the substance sample with the preselected reagents for a preselected mixing period, thus producing a measurand having a target substance reaction.”

U.S. Pat. No. 6,470,730 for a dry transfer method for the preparation of explosives test samples issued Oct. 29, 2002 to Robert T. Chamberlain and assigned to The United States of America as represented by the Secretary of Transportation provides the following state of the art information, “ . . . method of preparing samples for testing explosive and drug detectors of the type that search for particles in air. A liquid containing the substance of interest is placed on a flexible Teflon® surface and allowed to dry, then the Teflon® surface is rubbed onto an item that is to be tested for the presence of the substance of interest. The particles of the substance of interest are transferred to the item but are readily picked up by an air stream or other sampling device and carried into the detector.”

### SUMMARY

Features and advantages of the present invention will become apparent from the following description. Applicants are providing this description, which includes drawings and examples of specific embodiments, to give a broad representation of the invention. Various changes and modifications within the spirit and scope of the invention will become apparent to those skilled in the art from this description and by practice of the invention. The scope of the invention is not intended to be limited to the particular forms disclosed and the invention covers all modifications, equivalents, and alternatives falling within the spirit and scope of the invention as defined by the claims.

The present invention provides an inspection tester system for testing for explosives. One embodiment of the system comprising a body, a lateral flow membrane swab unit operably connected to the body, a first explosives detecting reagent, a first reagent holder and dispenser operatively connected to the body, the first reagent holder and dispenser containing the first explosives detecting reagent and positioned to deliver the first explosives detecting reagent to the lateral flow membrane swab unit, a second explosives detecting reagent, and a second reagent holder and dispenser operatively connected to the body, the second reagent holder and dispenser containing the second explosives detecting reagent and positioned to deliver the second explosives detecting reagent to the lateral flow membrane swab unit.

Another embodiment of the present invention provides an inspection tester method for testing a suspect surface for explosives. The method comprises the steps of providing a lateral flow membrane swab unit positioned on a body unit; providing a first explosives detecting reagent; providing a second explosives detecting reagent; swiping the suspect surface with the lateral flow membrane swab unit, delivering the first explosives detecting reagent to the lateral flow membrane swab unit, wherein if the lateral flow membrane swab unit becomes colored the test is positive for explosives and if no color appears the test for explosives is negative to this point; and delivering the second explosives detecting reagent to the lateral flow membrane swab unit, wherein if the lateral flow membrane swab unit becomes colored the test is positive for explosives and if no color appears the test for explosives is negative.

The present invention provides an all-inclusive, inexpensive, and disposable device. The present invention can be used anywhere as a primary screening tool by non-technical personnel to determine whether a surface contains explosives. The present invention can be used by first responders, military, law enforcement and Homeland Security.

The invention is susceptible to modifications and alternative forms. Specific embodiments are shown by way of example. It is to be understood that the invention is not limited to the particular forms disclosed. The invention covers all modifications, equivalents, and alternatives falling within the spirit and scope of the invention as defined by the claims.

### BRIEF DESCRIPTION OF THE DRAWINGS

The accompanying drawings, which are incorporated into and constitute a part of the specification, illustrate specific embodiments of the invention and, together with the general description of the invention given above, and the detailed description of the specific embodiments, serve to explain the principles of the invention.

FIG. 1 show a top view of an embodiment of a system constructed according to the invention.

FIG. 1 is a side view of the embodiment of a system illustrated in FIG. 1.

FIG. 3 show a perspective view of the embodiment of a system constructed according to the invention illustrated in FIGS. 1 and 2 together with a heating unit.

FIG. 4 illustrates the Meisenheimer complex.

FIG. 5 illustrates the Griess Reagent reaction.

### DETAILED DESCRIPTION OF THE INVENTION

Referring now to the drawings, to the following detailed description, and to incorporated materials, detailed information about the invention is provided including the description of specific embodiments. The detailed description serves to explain the principles of the invention. The invention is susceptible to modifications and alternative forms. The invention is not limited to the particular forms disclosed. The invention covers all modifications, equivalents, and alternatives falling within the spirit and scope of the invention as defined by the claims.

Quick identification of the presence of trace levels of explosives is of paramount interest to government agencies, airport security, and other entities throughout the world. Various systems for such analysis have been marketed but these typically have limited application due to fieldability problems (size, complexity, time to develop a sample, etc.), limited analytical ability (not sensitive enough), and being too sensitive (false positive indications).

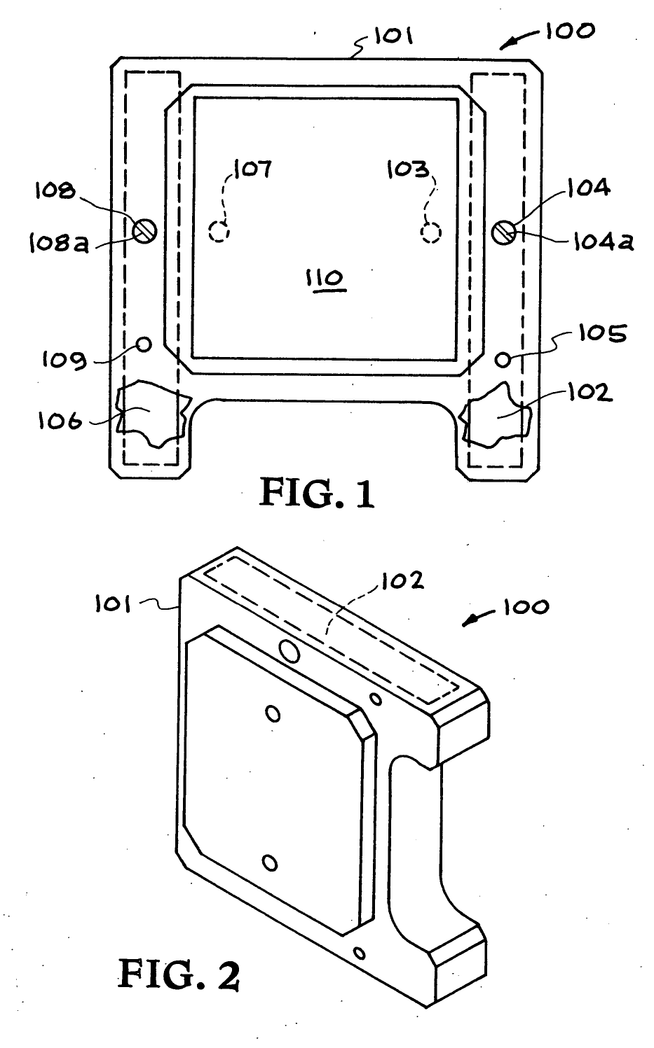

Referring now to the drawings and in particular to FIG. 1, an embodiment of an inspection tester for explosives constructed in accordance with the present invention is illustrated. This embodiment of the present invention is designated generally by the reference numeral 100. The explosives detection system 100 will be described in a summary manner. The system 100 for the quick screening of explosives has two basic components. The first component is the chemistry and method involved in this colorimetric test. The colorimetric chemistry incorporates, but is not limited to, the Meisenheimer complex and a Griess Reagent. The second is the apparatus used to sample an area potentially contaminated with explosives, the delivery system for the chemicals, and the heater used to promote the calorimetric reaction.

The chemistry used in the system 100 has been available for many years. However, it was used to identify explosives using Thin Layer Chromatography (TLC) and not for a quick colorimetric spot testing for the presents of explosives. The TLC method consists of spotting a sample on to a TLC plate and then exposing the bottom of the plate to a solvent system on the plate carrying the explosives with it. The explosives, having a different affinity for the solvent and the surface of the TLC plate, stop at different points on the plate thus separating the explosives on the plate. Various reagents and heat can then be used to color the different explosives and identify them. The system 100 uses some of the same chemistry, but is not concerned with identifying specific explosives. It is used to determine the presents of explosives. This eliminates the need for all of the TLC apparatus, solvents, and the chromatography itself. The system 100 uses coloring reagents from the TLC system. Instead of applying a sample to a thin layer plate the system 100 swipes a lateral flow membrane 110 to a surface. The system 100 uses a base (reagent A) to check for one class of explosives. In the system 100 the lateral flow membrane 110 is heated and this can detect more explosives. In the system 100, a Griess reagent is used to check for a number of other explosives.

The apparatus of the system 100 comprises a small plastic coupon that functions as a sampling device and the area where the chemistry is performed and observed. The system 100 provides a small, one time use device. The coupon comprises two airtight reservoirs 102 and 106 on each side of a body 101 that hold the reagents A and B. Each reservoir 102 and 106 has a puncture screw that is used to rupture the reservoir and release the reagents onto the lateral flow membrane 110. After a surface is swiped with the coupon or a separate swipe, reagent A is released and any color change indicates the presents of explosives. The coupon then slides into a small portable heater for the heating step, and a color change at this step indicates the presence of explosives. Reservoir B 106 is ruptured and the swipe is exposed to reagent B. Any color change indicates the presents of explosives. The coupon can then be discarded and another used for a new sampling.

The inspection tester 100 is an all-inclusive, inexpensive, and disposable device. The inspection tester can be used anywhere as a primary screening tool by non-technical personnel to determine whether a surface contains explosives. The inspection tester 100 was developed to allow identification of explosives. This inspection tester may be of used by first responders, military, law enforcement and Homeland Security.

A top view of the inspection tester 100 constructed according to the invention is shown in FIG. 1. The system 100 includes the following structural elements: a body 101, reservoir A 102, drain hole 103 for reservoir A, puncture hole 104 for reservoir A, fill hole 105 for reservoir A, reservoir B 106, drain hole 107 for reservoir B, puncture hole 108 for reservoir B, fill hole 109 for reservoir B, and lateral flow membrane 110.

The body 101 can be made of plastic, fiber glass, paper, glass, or other suitable substance. The reservoir A is adapted to hold reagent A. The reservoir B is adapted to hold reagent B. The puncture hole 104 for reservoir A is normally sealed to retain reagent A in reservoir A until the system 100 is ready for operation. At that time a device is used to open the puncture hole 104. For example, the screw 104A is show for opening the puncture hole 104. The puncture hole 108 for reservoir B is normally sealed to retain reagent B in reservoir B until the system 100 is ready for operation. At that time a device is used to open the puncture hole 108. For example, the screw 108A is show for opening the puncture hole 108.

The lateral flow membrane 110 is positioned on the explosives tester body 101. The lateral flow membrane 110 may be affixed to the explosives tester body 101 or it may be loosely positioned on the explosives tester body 101. The lateral flow membrane 110 is microporous cellulose nitrate membrane that provides migration of the fluids from reservoir A 102 and reservoir B 107. The lateral flow membrane 110 comprises a microporous cellulose nitrate membrane that provides migration of fluids from reservoir A 102 and fluids from reservoir B 106. The lateral flow membrane 110 shown in FIG. 1 is a Porex Lateral-Flo Membrane. The lateral flow membrane 110 comprises polyethylene spheres fused into a Lateral-Flo™ membrane. Applicants experimentally determined that the properties of Porex make it an ideal swipe material for the inspection tester 100. The lateral flow membrane 110 is chemical resistant, withstands heat as high as 130° C., is durable, is inexpensive, can be cut to any size, and concentrates suspect materials along the solvent front making calorimetric detection limits. The lateral flow membrane 110 provides a high surface area swipe for sample collection.

The lateral flow membrane 110 is exposed to a suspect substance. This may be accomplished by the lateral flow membrane 110 attached to the body 101 being swiped across a surface containing the suspect substance. Alternatively, the lateral flow membrane 110 may be separately exposed to the suspect substance and positioned on the body 101. The lateral flow membrane 110 may be exposed to a suspect substance in other ways such as adding the suspect substance to the lateral flow membrane 110. The inspection tester 100 provides a small, disposable, one use system. The inspection tester 100 provides a simple and rapid method of operation.

The inspection tester 100 has use as a stand alone, rapid, disposable, calorimetric test for explosives to be used by field personnel to determine explosives presence. This system is a quick screening test for the presence of explosives. It has particular use by the EPA, US Military, CDC, ATF, National Guard IAEA, etc. The inspection tester 100 will augment existing capabilities and kits developed for field analysis of explosives. The inspection tester 100 can be used by law enforcement, military, firefighters, first responders, and others interested in finding the presence of explosives.

Referring now to FIG. 2, a side view of the system of FIG. 1 is shown. The side view shows reservoir A 102 in body 101. The reservoir A 102 holds the reagent A. The lateral flow membrane is exposed to a suspect substance. This may be accomplished by the lateral flow membrane attached to the body 101 being swiped across a surface containing the suspect substance. The puncture hole for reservoir is opened and the reagent A is dispensed onto the lateral flow membrane attached to the body 101.

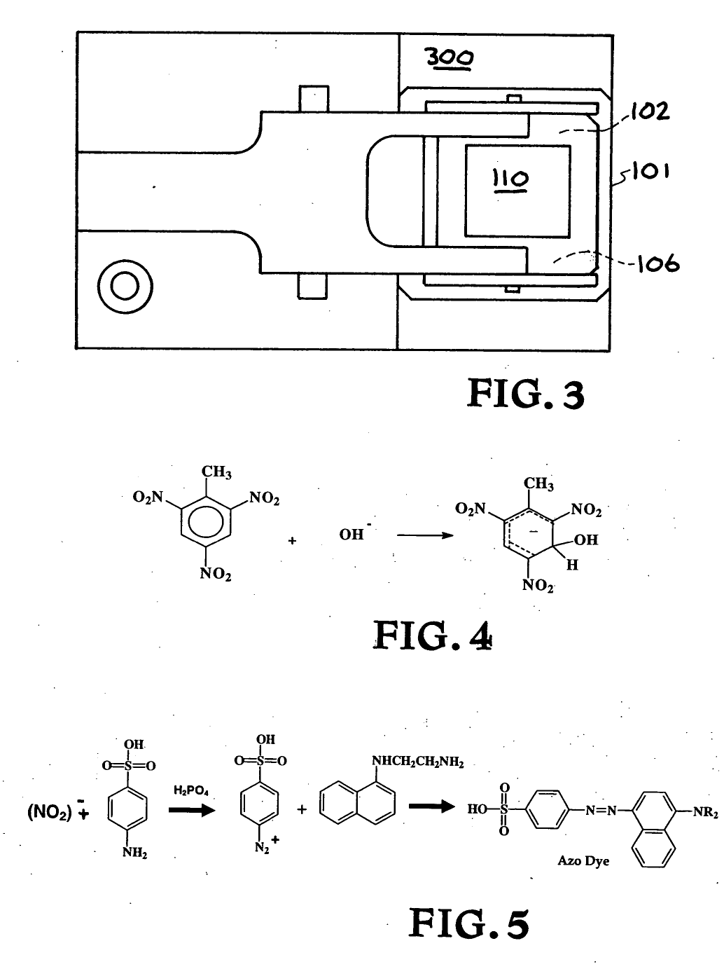

Referring now to FIG. 3, operation of the explosive tester 100 will be described including the step of positioning the explosive tester 100 in a portable heating unit 300. The reservoir A 102 and reservoir B 106 provide two reagent activation units. Reservoir A 102 (for reagent A) and reservoir B 106 (for reagent B) are operatively positioned on the explosives tester body 102. The reservoir A 102 containing the first explosives detecting reagent A is positioned to deliver the first explosives detecting reagent A to the lateral flow membrane 110. The reservoir B 106 containing the second explosives detecting reagent B is positioned to deliver the second explosives detecting reagent B to the lateral flow membrane 110. The reagent A contains Meisenheimer complexes. FIG. 4 shows the Meisenheimer complexes reaction. The reagent B provides a Griess reagent. FIG. 5 shows the Griess reagent reaction. The Meisenheimer complexes and Griess reaction are well known in the art and need not be described here.

The inspection tester 100 uses a simple and rapid procedure summarized by the following four step operation:

STEP 1) A suspect surface is swiped with the lateral flow membrane 110. This may be accomplished by the lateral flow membrane 110 being swiped across a surface containing the suspect substance or the lateral flow membrane 110 may be exposed to the suspect substance in other ways such as adding the suspect substance to the lateral flow membrane 110. This will cause any explosives residue to be collected and held by the lateral flow membrane 110.

STEP 2) The reservoir A 102 is located in a position to deliver the first explosives detecting reagent A to the lateral flow membrane 110. The reservoir A 102 is opened by puncturing the reservoir A puncture hole 104. This may be accomplished using the screw 104A. The opening of the reservoir A puncture hole 104 dispenses reagent A onto the lateral flow membrane 111. The regent A contacts any explosives residue that has been collected by the swab unit sample pad 101. The lateral flow membrane 110 concentrates suspect materials along the solvent front. If the lateral flow membrane 110 becomes colored, the test is positive for explosives. If no color appears the test for explosives is negative to this point.

STEP 3) If STEP 2 is negative to this point, the inspection tester 100 is positioned in the portable heating unit 300 as illustrated in FIG. 3. The heating unit 300 is activated. This causes the lateral flow membrane 110, reagent A, and any explosives residue to become heated. If the lateral flow membrane 110 now becomes colored, the test is positive for explosives. If no color appears the test for explosives is negative to this point.

STEP 4) The reservoir B 106 is located in a position to deliver the second explosives detecting reagent B to the lateral flow membrane 110. If STEP 3 is negative to this point, the reservoir B 10B 106 is opened by puncturing the reservoir B puncture hole 108. This may be accomplished using the screw 108A. The opening of the reservoir B puncture hole 108 dispenses reagent B onto the lateral flow membrane 110. The regent B contacts any explosives residue that has been collected by the lateral flow membrane 110. The lateral flow membrane 110 concentrates suspect materials along the solvent front. If the lateral flow membrane 110 becomes colored, the test is positive for explosives. If no color appears the test for explosives is negative.

The inspection tester 100 provides a simple, chemical, field spot-test by to provide a rapid screen for the presence of a broad range of explosive residues. The inspection tester 100 is fast, extremely sensitive, low-cost, very easy to implement, and provides a very low rate of false positives. The inspection tester for explosives 100 provides a fast, sensitive, low-cost, very easy to implement system for testing the suspected packages. The inspection tester for explosives 100 is inexpensive and disposable. The inspection tester for explosives 100 has detection limits between 0.1 to 100 nanograms, depending on the type of explosives present. A large number of common military and industrial explosives can be easily detected such as HMX, RDX, NG, TATB, Tetryl, PETN, TNT, DNT, TNB, DNB and NC. The inspection tester 100 is small enough that a number of them can fit in a pocket or brief case.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

The invention claimed is:

1. An inspection tester apparatus for testing for explosives, comprising:
a body,
a lateral flow membrane swab unit operably connected to said body,
a first explosives detecting reagent,
a first reagent holder and dispenser operatively connected to said body, said first reagent holder and dispenser containing said first explosives detecting reagent and positioned to deliver said first explosives detecting reagent to said lateral flow membrane swab unit,
a second explosives detecting reagent, and
a second reagent holder and dispenser operatively connected to said body, said second reagent holder and dispenser containing said second explosives detecting reagent and positioned to deliver said second explosives detecting reagent to said lateral flow membrane swab unit.

2. The inspection tester apparatus for testing for explosives of claim 1 wherein said lateral flow membrane swab unit comprises a microporous membrane.

3. The inspection tester apparatus for testing for explosives of claim 1 wherein said lateral flow membrane swab unit comprises a polyethylene spheres fused membrane.

4. The inspection tester apparatus for testing for explosives of claim 1 wherein said lateral flow membrane swab unit comprises a microporous cellulose membrane.

5. The inspection tester apparatus for testing for explosives of claim 1 wherein said lateral flow membrane swab unit comprises a microporous cellulose nitrate membrane.

6. The inspection tester apparatus for testing for explosives of claim 1 wherein said lateral flow membrane swab unit comprises a microporous membrane that provides migration of said first explosives detecting reagent from said first reagent holder and dispenser and migration of said second explosives detecting reagent from said second reagent holder and dispenser.

7. The inspection tester apparatus for testing for explosives of claim 1 wherein said body is a plastic body.

8. The inspection tester apparatus for testing for explosives of claim 1 wherein said body is a paper body.

9. The inspection tester apparatus for testing for explosives of claim 1 wherein said body is a fiber glass body.

10. The inspection tester apparatus for testing for explosives of claim 1 wherein said body is a glass body.

11. The inspection tester apparatus for testing for explosives of claim 1 wherein said first explosives detecting reagent comprises Meisenheimer complexes.

12. The inspection tester apparatus for testing for explosives of claim 1 wherein said second explosives detecting reagent comprises a Griess reagent.

13. The inspection tester apparatus for testing for explosives of claim 1 wherein said first explosives detecting reagent comprises Meisenheimer complexes and wherein said second explosives detecting reagent comprises a Griess reagent.

14. The inspection tester apparatus for testing for explosives of claim 1 wherein said first reagent holder and dispenser comprises a reservoir in said body.

15. The inspection tester apparatus for testing for explosives of claim 1 wherein said first reagent holder and dispenser comprises a reservoir in said body with puncture hole.

16. The inspection tester apparatus for testing for explosives of claim 1 wherein said second reagent holder and dispenser comprises a reservoir in said body.

17. The inspection tester apparatus for testing for explosives of claim 1 wherein said second reagent holder and dispenser comprises a reservoir in said body with puncture hole.

18. An inspection tester method for testing a suspect surface for explosives, comprising the steps of:
providing a lateral flow membrane swab unit positioned on a body unit;
providing a first explosives detecting reagent;
providing a second explosives detecting reagent;
swiping said suspect surface with said lateral flow membrane swab unit,
delivering said first explosives detecting reagent to said lateral flow membrane swab unit, wherein if said lateral flow membrane swab unit becomes colored the test is positive for explosives and if no color appears the test for explosives is negative to this point; and
delivering said second explosives detecting reagent to said lateral flow membrane swab unit, wherein if said lateral flow membrane swab unit becomes colored the test is positive for explosives and if no color appears the test for explosives is negative.

19. The inspection tester method for testing a suspect surface for explosives of claim 18 including the step of heating said lateral flow membrane swab unit after said step of delivering said first explosives detecting reagent to said lateral flow membrane swab unit, wherein no color appears and the test for explosives is negative to that point.

20. The inspection tester method for testing a suspect surface for explosives of claim 18 wherein said step of delivering said first explosives detecting reagent to said lateral flow membrane swab unit comprises delivering a Meisenheimer complexes detecting reagent to said lateral flow membrane swab unit, wherein if said lateral flow membrane swab unit becomes colored the test is positive for explosives and if no color appears the test for explosives is negative to this point.

21. The inspection tester method for testing a suspect surface for explosives of claim 18 wherein said step of delivering said second explosives detecting reagent to said lateral flow membrane swab unit comprises delivering a Griess reagent detecting reagent to said lateral flow membrane swab unit, wherein if said lateral flow membrane swab unit becomes colored the test is positive for explosives and if no color appears the test for explosives is negative.

22. The inspection tester method for testing a suspect surface for explosives of claim 18 wherein said first explosives detecting reagent comprises Meisenheimer complexes and wherein said second explosives detecting reagent comprises a Griess reagent.
